(19) United States
(12) Patent Application Publication
(10) Pub. No.: US 2015/0279407 A1
(43) Pub. Date: Oct. 1, 2015

(54) METHOD OF MANUFACTURING HEXAGONAL FERRITE POWDER, HEXAGONAL FERRITE POWDER, AND MAGNETIC RECORDING MEDIUM

(71) Applicant: FUJIFILM Corporation, Tokyo (JP)

(72) Inventor: Yoichi HOSOYA, Minami-ashigara-shi (JP)

(73) Assignee: FUJIFILM Corporation, Tokyo (JP)

(21) Appl. No.: 14/673,180

(22) Filed: Mar. 30, 2015

(30) Foreign Application Priority Data
Mar. 31, 2014 (JP) 2014-074667
Mar. 30, 2015 (JP) 2015-069164

(51) Int. Cl. G11B 5/706; G11B 5/714; H01F 1/37; C01G 49/00; H01F 1/34

(52) U.S. Cl. CPC G11B 5/70678; C01G 49/0036; H01F 1/348; H01F 1/37; G11B 5/714; C01P 2006/42; C01P 2004/64

(57) ABSTRACT

An aspect of the present invention relates to a method of manufacturing hexagonal ferrite powder, which comprises introducing a hexagonal ferrite precursor and an organic compound, either simultaneously or sequentially, into a feed passage into which water is being continuously fed while being heated and pressurized, continuously feeding a water-based solution comprising at least the hexagonal ferrite precursor, the organic compound, and water through the feed passage to a reaction flow passage within which a fluid flowing therein is subjected to heating and pressurizing to convert the hexagonal ferrite precursor into hexagonal ferrite in the reaction flow passage, discharging and feeding a water-based comprising the hexagonal ferrite from the reaction flow passage to a cooling element, and recovering the hexagonal ferrite from the water-based solution that has been cooled in the cooling element, wherein a solution temperature at the point of first contact between the hexagonal ferrite precursor and the organic compound is equal to or higher than 200° C. but lower than 300° C., and a pH of the water-based solution that has been cooled is equal to or higher than 6.0 but equal to or lower than 12.0.

### CROSS-REFERENCE TO RELATED APPLICATIONS

This application claims priority under 35 U.S.C 119 to Japanese Patent Application No. 2014-074667 filed on Mar. 31, 2014 and Japanese Patent Application No. 2015-69164 filed on Mar. 30, 2015. Each of the above applications is hereby expressly incorporated by reference, in its entirety.

### BACKGROUND OF THE INVENTION

1. Field of the Invention

The present invention relates to a method of manufacturing hexagonal ferrite powder, hexagonal ferrite powder, and a magnetic recording medium

2. Discussion of the Background

Hexagonal ferrite powder is widely employed as the ferromagnetic powder contained in the magnetic layers of magnetic recording media. The coercive force thereof is great enough for use in permanent magnetic materials. The magnetic anisotropy that is the basis of the coercive force derives from its crystal structure. Thus, high coercive force can be maintained even when the size of the particles is reduced. Further, magnetic recording media employing hexagonal ferrite in a magnetic layer have high density characteristics due to the vertical component. Thus, hexagonal ferrite is ferromagnetic powder that is suited to high density recording.

Hexagonal ferrite powder can be manufactured by various methods, including the coprecipitation and glass crystallization methods. Manufacturing methods utilizing a hydrothermal synthesis reaction in the presence of high-temperature, high-pressure water, referred to as supercritical or subcritical water, have also been proposed (for example, see Japanese Unexamined Patent Publication (KOKAI) No. 2009-208969, which is expressly incorporated herein by reference in its entirety).

### SUMMARY OF THE INVENTION

The above hydrothermal synthesis process has attracted attention in recent years as a method permitting the manufacturing of hexagonal ferrite powder with high productivity.

Recording densities have been rapidly increasing in the field of magnetic recording in recent years. Improvement in electromagnetic characteristics is required to achieving still higher recording densities.

Magnetic recording media, particularly high-density recording media such as backup tapes, are required to afford highly reliable use over extended periods, that is, good running durability. To this end, particulate magnetic recording media having a magnetic layer (coating) containing ferromagnetic powder and binder (also referred to simply as “magnetic recording media”, hereinafter) desirably have high coating durability without producing numerous scrapings due to the magnetic layer sliding against the head during recording and reproduction.

As set forth above, a magnetic recording medium is required to achieve both good electromagnetic characteristics and a magnetic layer with good coating durability. Based on research by the present inventor, in a magnetic recording medium with a magnetic layer containing hexagonal ferrite powder obtained by the conventional hydrothermal synthesis process, it is difficult to obtain both of these.

An aspect of the present invention provides for a method of manufacturing hexagonal ferrite powder permitting the fabrication of a magnetic recording medium capable of exhibiting good electromagnetic characteristics and affording a magnetic layer with good coating durability.

The present inventor engaged in extensive trial and error. As a result, he discovered the following manufacturing method utilizing a hydrothermal synthesis process:

a method of manufacturing hexagonal ferrite powder, which comprises:

introducing a hexagonal ferrite precursor and an organic compound, either simultaneously or sequentially, into a feed passage into which water is being continuously fed while being heated and pressurized;

continuously feeding a water-based solution comprising at least the hexagonal ferrite precursor, the organic compound, and water through the feed passage to a reaction flow passage within which a fluid flowing therein is subjected to heating and pressurizing to convert the hexagonal ferrite precursor into hexagonal ferrite in the reaction flow passage;

discharging and feeding a water-based comprising the hexagonal ferrite from the reaction flow passage to a cooling element; and

recovering the hexagonal ferrite from the water-based solution that has been cooled in the cooling element; wherein

a solution temperature at the point of first contact between the hexagonal ferrite precursor and the organic compound is equal to or higher than 200° C. but lower than 300° C.; and

a pH of the water-based solution that has been cooled is equal to or higher than 6.0 but equal to or lower than 12.0.

In the above manufacturing method, the solution temperature during mixing (the above “point of first contact”) of the hexagonal ferrite precursor, organic compound, and heated and pressurized water (also referred to as “heated and pressurized water”, hereinafter) and the pH of the water-based solution following cooling in the cooling element are set to within the above ranges, respectively. Through extensive research conducted by the present inventor, it was discovered that a magnetic recording medium containing the hexagonal ferrite powder thus obtained as ferromagnetic powder in a magnetic layer can exhibit good electromagnetic characteristics and that the magnetic layer thereof can exhibit good coating durability.

In this regard, the present inventor thinks that the fact that the above manufacturing method can yield hexagonal ferrite powder of small particle size and little variation in particle size can contribute to enhancing the electromagnetic characteristics and coating durability (coating strength) of the magnetic layer. The present inventor presumes that the above manufacturing method may tend to form hexagonal ferrite having an isotropic shape, and that this can contribute to enhancing the coating durability of the magnetic layer. However, this is merely conjecture by the present inventor, and does not limit the present invention in any way.

When, for example, a flow passage of a solution containing hexagonal ferrite precursor and an organic compound is converged with a feed passage to which high-temperature, high-pressure water is being fed, the “point of first contact” is the point where the flow passage and the feed passage converge.

Further, if the flow passage of the hexagonal ferrite precursor-containing solution is converged with the feed passage to which the high-temperature, high-pressure water is fed, after which a flow passage of solution containing the organic compound is converged with the feed passage at a point positioned to the downstream side thereof, the “point of first contact” will be the point of converging of the feed passage and the flow passage of the organic compound-containing solution. In this context, the term “to the downstream side” refers to the side nearer the reaction flow passage in the feeding direction within the feed passage. The “upstream side” referred to further below refers to the opposite.

Conversely, if the flow passage of the organic compound-containing solution is converged with the feed passage to which the high-temperature, high-pressure water is fed, and the flow passage of the hexagonal ferrite precursor-containing solution is subsequently converged with the feed passage at a point positioned downstream from this point of converging, the “point of first contact” will be the point of converging of the flow passage of the hexagonal ferrite precursor-containing solution with the feed passage.

The solution temperature at the above “point of first contact” can be measured by a known temperature measuring means, such as a thermocouple.

The pH of the water-based solution following the above cooling refers to the pH of the water-based solution that has been discharged through the discharge outlet of the cooling element. At least some portion of the water-based solution that has been discharged through the discharge outlet is collected at some position and adjusted to a solution temperature of 25° C., and the pH is measured.

In an embodiment, the water-based solution comprising the hexagonal ferrite precursor and the solution comprising the organic compound are sequentially, or following mixing, introduced into the feed passage.

In an embodiment, the water-based solution comprising the hexagonal ferrite precursor is introduced into the feed passage, after which the solution containing the organic compound is introduced.

In an embodiment, the above method further comprises mixing an iron salt, divalent metal salt, and a base in a water-based solution to prepare a water-based solution that comprises the hexagonal ferrite precursor.

In an embodiment, the iron salt is a barium salt.

In an embodiment, the water-based solution comprising the hexagonal ferrite precursor is prepared by conducting the mixing in a reaction tank.

In an embodiment, the water-based solution comprising the hexagonal ferrite precursor is prepared by converging a feed passage to which a solution comprising an iron salt and a divalent metal salt is being fed with a feed passage to which a base-containing water-based solution is being fed to mix the two solutions.

In an embodiment, the water-based solution comprising at least the hexagonal ferrite precursor, the organic compound, and water is continuously fed while being heated to equal to or higher than 300° C. and pressurized to equal to or higher than 20 MPa in the reaction flow passage.

In an embodiment, the solution temperature of the water-based solution being discharged from the reaction flow passage to the cooling element is equal to or higher than 350° C. but equal to or lower than 450° C. In this context, the solution temperature of the water-based solution being discharged from the reaction flow passage and fed to the cooling element refers to the solution temperature at the discharge outlet of the reaction flow passage and can be measured by a known temperature measuring means such as a thermocouple.

In an embodiment, the water-based solution is cooled to a solution temperature of equal to or lower than 100° C. in the cooling element.

In an embodiment, the water that is being continuously fed while being heated and pressurized is heated to equal to or higher than 200° C. and pressurized to equal to or higher than 20 MPa.

In an embodiment, the organic compound is selected from the group consisting of an organic carboxylic acid and a salt thereof.

In an embodiment, the organic compound is selected from the group consisting of an organic carboxylic acid with a carbon number ranging from 2 to 24 and a salt thereof.

In an embodiment, the organic compound is selected from the group consisting of oleic acid and a salt thereof.

A further aspect of the present invention relates to hexagonal ferrite powder manufactured by the above manufacturing method.

In an embodiment, the hexagonal ferrite powder has an average particle size ranging from 10 nm to 30 nm.

In this context, the particle size in the present invention refers to the major axis length, except in the cases specifically excluded below, and the average particle size refers to the average major axis length. The particle size is a value obtained by observation by a transmittance electron microscope. More specifically, the major axis length of 500 particles in a particle photograph directly taken with an electron microscope with an acceleration voltage of 100 kV (with a model H-9000 transmission electron microscope made by Hitachi, for example) is obtained, and the average value (arithmetic mean) of the major axis lengths of the 500 particles is adopted as the average major axis length. More specifically, a particle photograph is taken at a magnification of 100,000-fold and printed on photographic paper to a total magnification of 500,000-fold. Target particles are selected from the particle photograph, the outlines of the powder are traced with a digitizer, and image analysis software (such as Carl Zeiss image analyzing software KS-400) is used to measure the major axis length of the particles. The term “major axis length” refers to determining the longest axis (line) that can be run through the particle as the major axis, and taking the length of that axis. The term “minor axis” refers to determining the longest axis that can be run through the particle as a straight line perpendicular to the major axis, and adopting the length of that axis as the minor axis length. However, when the major axis constituting a particle cannot be specified due to the shape, the term particle size refers to the equivalent spherical diameter and the average particle size refers to the average equivalent spherical diameter. Specifically, a particle photograph is directly taken with an electron microscope (a model H-9000 transmission electron microscope made by Hitachi, for example) at an acceleration voltage of 100 kV, equivalent spherical diameters are obtained for the projected areas of 500 particles in the photograph, and the average value of the 500 particles is adopted as the average equivalent spherical diameter. The coefficient of variation in particle size mentioned farther below is a value obtained by calculating the standard deviation of the particle size of the 500 particles and dividing it by the average particle size.

The particle size set forth above can be obtained by observing the powder that is present as powder by a transmission electron microscope. A measurement sample of the powder that is contained in a magnetic recording medium can be obtained by collecting powder from the magnetic recording medium. The measurement sample can be collected, for example, from a magnetic layer by the following method.

1. Subjecting the surface of the magnetic layer to 1 to 2 minutes of surface treatment with a plasma reactor made by Yamato Scientific Co., Ltd., and ashing the organic components (binder, curing agent and the like) of the surface of the magnetic layer to remove them.

2. Adhering filter paper that has been immersed in an organic solvent such as cyclohexanone or acetone to the edge portion of a metal rod, rubbing the surface of the magnetic layer that has been treated as in 1. above on it, and transferring the magnetic layer component from the magnetic layer to the filter paper to separate it.

3. Shaking off the component separated by 2. above in a solvent such as cyclohexanone or acetone (placing each piece of filter paper in solvent and using an ultrasonic disperser to shake it off), drying the solvent, and removing the separated component.

4. Placing the component that has been scraped off in 3. above in a glass test tube that has been thoroughly cleaned, adding n-butyl amine to about 20 mL of the magnetic layer component, and sealing the glass test tube. (The n-butyl amine is added in a quantity adequate to decompose the remaining binder or the like that has not been ashed.)

5. The glass test tube is heated for equal to or more than 20 hours at 170° C. to decompose the organic component.

6. The precipitate following the decomposition of 5. above is thoroughly washed with pure water and dried, and the powder is recovered.

7. A neodymium magnet is placed near the powder that has been collected in 6. and the powder that is attracted (that is, magnetic powder) is collected.

Ferromagnetic powder can be collected from the magnetic layer by the above steps. Since the above processing can impart almost no damage to the particles, the above method permits measurement of the particle size of powder in the state in which it was contained in the magnetic layer.

A further aspect of the present invention relates to a magnetic recording medium, which comprises a magnetic layer comprising ferromagnetic powder and binder on a nonmagnetic support, wherein the ferromagnetic powder is the above hexagonal ferrite powder.

An aspect of the present invention can provide a magnetic recording medium having both good electromagnetic characteristics and a magnetic layer with high coating durability.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the drawing, wherein:

FIG. 1 is schematic descriptive drawing of an example of a manufacturing device that can be used in the manufacturing method according to an aspect of the present invention.

FIG. 2 is schematic descriptive drawing of an example of a manufacturing device that can be used in the manufacturing method according to an aspect of the present invention.

FIG. 3 is schematic descriptive drawing of an example of a manufacturing device that can be used in the manufacturing method according to an aspect of the present invention.

FIG. 4 is schematic descriptive drawing of an example of a manufacturing device that can be used in the manufacturing method according to an aspect of the present invention.

FIG. 5 is schematic descriptive drawing of an example of a manufacturing device that can be used in the manufacturing method according to an aspect of the present invention.

FIG. 6 is a schematic sectional view of a batch-type reaction tank employed to prepare a precursor-containing water-based solution in Examples.

### DETAILED DESCRIPTION OF THE EMBODIMENTS

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Method of Manufacturing Hexagonal Ferrite Powder

An aspect of the present invention relates to:

a method of manufacturing hexagonal ferrite powder, which comprises:

introducing a hexagonal ferrite precursor and an organic compound, either simultaneously or sequentially, into a feed passage into which water is being continuously fed while being heated and pressurized;

continuously feeding a water-based solution comprising at least the hexagonal ferrite precursor, the organic compound, and water through the feed passage to a reaction flow passage within which a fluid flowing therein is subjected to heating and pressurizing to convert the hexagonal ferrite precursor into hexagonal ferrite in the reaction flow passage;

discharging and feeding a water-based comprising the hexagonal ferrite from the reaction flow passage to a cooling element; and

recovering the hexagonal ferrite from the water-based solution that has been cooled in the cooling element; wherein

a solution temperature at the point of first contact between the hexagonal ferrite precursor and the organic compound is equal to or higher than 200° C. but lower than 300° C.; and

a pH of the water-based solution that has been cooled is equal to or higher than 6.0 but equal to or lower than 12.0.

As set forth above, the use of the hexagonal ferrite powder obtained by the above manufacturing method as ferromagnetic powder in a magnetic layer can permit the formation of a magnetic layer affording high coating durability. Further, a magnetic recording medium having this magnetic layer can exhibit good electromagnetic characteristics.

This manufacturing method will be described in greater detail below.

<Preparation of Hexagonal Ferrite Precursor>

(i) Starting Materials (Iron Salt, Divalent Metal Salt)

It suffices for the hexagonal ferrite precursor to convert to hexagonal ferrite (ferrite conversion) when placed in the presence of high-temperature, high-pressure water. High-temperature, high-pressure water refers to water that has been heated and pressurized. A detailed description will be given further below. In an embodiment, the precursor may exhibit high solubility in water and dissolve in the water-based solvents described further below. In another embodiment, those that have poor solubility in water can be rendered as dispersions (sols) of colloidal particles in the water-based solvent.

Magnetoplumbite (M-type), W-type, Y-type, and Z-type crystal structures of hexagonal ferrite are known. The hexagonal ferrite obtained by the above manufacturing method can be of any crystal type. For example, M-type hexagonal ferrite not containing substitution atoms is a metal oxide denoted by AFe₁₂O₁₉. A denotes a divalent metal atom. The term “divalent metal atom” refers to a metal atom that is capable of becoming an ion in the form of a divalent cation. This includes alkaline earth metal atoms such as barium, strontium, and calcium, as well as lead and the like. The hexagonal ferrite may contain one or more substitution atoms that are substituted for a portion of the divalent metal atoms. When obtaining such hexagonal ferrite, it suffices to use a salt containing a substituent atom together with a divalent metal salt. Examples of atoms that can be substituted for divalent metal atoms are any of the atoms given further below. However, there is no limitation thereto.

The hexagonal ferrite precursor set forth above can be obtained by mixing an iron salt and a divalent metal salt in a water-based solution, desirably in a water-based solution containing a base. In this water-based solution, a salt containing iron atoms and divalent metal atoms (for example, a hydroxide) will precipitate in particle form, desirably as colloidal particles. The particles that precipitate out here can be subsequently placed in the presence of high-temperature, high-pressure water to convert them to ferrite and obtain hexagonal ferrite.

Salts of alkaline earth metals such as barium, strontium, and calcium, as well as lead salts can be employed as divalent metal salts. The type of divalent metal atom can be determined based on the desired hexagonal ferrite. For example, when barium ferrite is desired, a divalent metal salt in the form of a barium salt is employed. When strontium ferrite is desired, a strontium salt is employed. When mixed crystals of barium ferrite and strontium ferrite are desired, it suffices to employ divalent metal salts in the form of a barium salt and a strontium salt in combination. The salt is desirably a water-soluble salt. For example, hydroxides; halides such as chlorides, bromides, and iodides; and nitrates can be employed. Hydrates can also be employed.

Water-soluble salts of iron, such as halides such as chlorides, bromides, and iodides; nitrates; sulfates; carbonates; organic acid salts; and complexes can be employed as the iron salt. Hydrates can also be employed. The blending ratio and amounts added of the iron salt and divalent metal salt can be determined in accordance with the desired ferrite composition. In addition to an iron salt and a divalent metal salt, salts of optional atoms that are capable of constituting hexagonal ferrite along with iron atoms and divalent metal atoms can also be added. Examples of such optional atoms are Nb, Co, Ti, and Zn. The amounts of salts of these optional atoms that are added can be determined in accordance with the desired ferrite composition.

A hexagonal ferrite precursor containing the atoms that were contained in these salts will precipitate when the salts set forth above are mixed with a water-based solution desirably containing a base. Primarily hydroxide ions (OH⁻) in the water-based solution containing a base are thought to form a hydroxide sol with the iron ions contained in the iron salt and divalent metal ions contained in the divalent metal salt, thereby forming the precursor. The precursor that precipitates out here is subsequently converted to hexagonal ferrite (ferrite conversion).

(ii) Base

In the present invention, the base refers to one or more bases as defined by one or more among Arrhenius, Bronsted, or Lewis (Arrhenius bases, Bronsted bases, or Lewis bases). The same applies to the acids described in greater detail below; they are defined as one or more acids as defined by Arrhenius, Bronsted, or Lewis (Arrhenius acids, Bronsted acids, or Lewis acids).

Specific examples of bases are sodium hydroxide, potassium hydroxide, sodium carbonate, and ammonia water. However, there is no limitation thereto. Nor is there a limitation to inorganic bases; organic bases can also be employed. When the water-based solution for preparing the precursor contains a base, because salts exhibiting acidity will sometimes be added along with the base, the pH of the water-based solution is not limited to being alkaline. It will sometimes be neutral or acidic. In the above manufacturing method, as set forth above, the pH of the water-based solution that has been discharged from the reaction flow passage and cooled in the cooling element is kept to within a range of equal to or higher than 6.0 but equal to or lower than 12.0. One means of achieving this, for example, is to adjust the quantity of base when preparing the precursor to control the pH of the water-based solution for preparing the precursor. As needed, an acid can be added to adjust the pH. An acid in the form of any known acid such as hydrochloric acid, nitric acid, or sulfuric acid can be used without limitation to adjust the pH. Nor is the acid limited to inorganic acids; organic acids can also be employed. The pH of the water-based solution, as the pH at the solution temperature during preparation of the precursor (during the reaction), is equal to or higher than 4.0 but equal to or lower than 14.0, for example; desirably equal to or higher than 5.0 but equal to or lower than 14.0; preferably equal to or higher than 6.0 but equal to or lower than 13.0; more preferably equal to or higher than 6.0 but equal to or lower than 12.0.; and still more preferably equal to or higher than 7.0, or a pH exceeding 7.0 (neutral to alkaline). The temperature of the water-based solution during the reaction can be controlled by heating or cooling, or the temperature can be left unregulated at room temperature. The solution temperature desirably falls within a range of 10 to 90° C. Even when the temperature is unregulated (about 20 to 25° C., for example) the reaction will progress suitably. It suffices to equip the reaction tank that is set forth further below with a heating means or cooling means to control the temperature. The feed passage set forth further below can be heated with a heating means or cooled with a cooling means to control the temperature.

(iii) Water-Based Solvent

The water-based solvent refers to solvent containing water. Water alone will do, as will a mixed solvent of water and an organic solvent. The water-based solvent that is employed to prepare the precursor desirably comprises equal to or more than 50 weight percent of water, and is preferably water alone.

The organic solvent that can be employed in combination with water in the water-based solvent is desirably one that is miscible with water or that is hydrophilic. From this perspective, the use of a polar solvent is suitable. The term “polar solvent” refers to solvent that satisfies either having a dielectric constant of equal to or higher than 15 or having a solubility parameter of equal to or higher than 8. Desirable examples of organic solvents are alcohols, ketones, aldehydes, nitriles, lactams, oximes, amides, ureas, sulfides, sulfoxides, phosphoric acid esters, carboxylic acids, esters derived from carboxylic acids, carbonic acid or carbonic acid esters, and ethers.

(iv) Preparation of the Hexagonal Ferrite Precursor Solution

As set forth above, since the hexagonal ferrite precursor is normally prepared in a water-based solution, it is obtained as a water-based solution (hexagonal ferrite precursor solution) containing hexagonal ferrite precursor. In an embodiment, the hexagonal ferrite precursor solution can be prepared in a reaction tank. The reaction tank employed can be a batch-type reaction tank or a continuous-type reaction tank. With a batch-type reaction tank, removal of the reaction product is conducted in a separate step from feeding and reacting the starting materials. By contrast, with a continuous-type reaction tank, feeding and reaction of the starting materials are conducted in parallel with removal of the reaction product at least some of the time. Regardless of whether batch-type or continuous-type, in the reaction tank, the water-based solution containing the water-based solvent and the above components will normally be stirred and mixed with a known stirring means such as a magnetic stirrer. The various components, such as the above starting materials and base, can be fed into the reaction tank as solids or as liquids. To facilitate homogenization during mixing in the reaction tank, addition as liquids—for example, as a water-based solution obtained by dissolution or dispersion in a suitable solvent—is desirable. It suffices to suitably set the concentrations of starting materials and base in the water-based solvent. The various components can be simultaneously fed into the reaction tank, or such feeding can be sequentially begun in any order.

In another embodiment, the hexagonal ferrite precursor solution can be prepared by a continuous manufacturing process. A feed passage to which a liquid containing an iron salt and a divalent metal salt is being fed is desirably converged with a feed passage to which a base-containing water-based solution is being fed to mix these solutions and prepare a hexagonal ferrite precursor solution. The specific embodiment of such preparation will be described further below.

<Preparation of the Organic Compound and Organic Compound Solution>

In the above manufacturing method, a reaction is conducted in the presence of an organic compound since an organic compound is also fed to the reaction flow passage where the reaction converting the hexagonal ferrite precursor to hexagonal ferrite is conducted. Converting the hexagonal ferrite precursor to hexagonal ferrite in the presence of an organic compound is thought by the present inventor to contribute to obtaining hexagonal ferrite of small particle size. More specifically, once the hexagonal ferrite precursor has been instantaneously dissolved in the reaction flow passage (in a high-temperature, high-pressure system), it crystallizes. Thus, hexagonal ferrite particles are thought to precipitate out (convert to hexagonal ferrite). During the period from dissolution to crystallization, the fact that an organic compound is present near the particles is presumed by the present inventor to contribute to obtaining smaller crystallizing hexagonal ferrite microparticles and to rendering the particle size uniform. The organic compound which has been obtained by adding an organic compound to a solvent can be mixed with the precursor solution, or can be introduced to the feed passage to which high-temperature, high-pressure water is being fed.

(i) Organic Compound

Examples of the organic compound are organic carboxylic acids, organic nitrogen compounds, organic sulfur compounds, organic phosphorus compound, salts thereof, surfactants, and various polymers. Polymers having weight average molecular weights of about 1,000 to 100,000 are suitable. Those exhibiting solubility in water are desirable. Examples of desirable polymers are nonionic polymers and hydroxyl group-containing polymers. Alkali metal salts are suitable as the above salt. In the present invention, the weight average molecular weight refers to a value that is measured by gel permeation chromatography (GPC) and converted to a polystyrene equivalent.

Examples of organic carboxylic acids are aliphatic carboxylic acids, alicyclic carboxylic acids, and aromatic carboxylic acids. Aliphatic carboxylic acids are desirable. The aliphatic carboxylic acid may be a saturated aliphatic carboxylic acid or an unsaturated aliphatic carboxylic acid, with an unsaturated carboxylic acid being preferred. The number of carbon atoms of the carboxylic acid is not specifically limited; for example, it can be equal to or more than 2. By way of example, it can be equal to or lower than 24, desirably equal to or lower than 20, preferably equal to or lower than 16. Specific examples of aliphatic carboxylic acids are: oleic acid, linoleic acid, linolenic acid, caprylic acid, capric acid, lauric acid, behenic acid, stearic acid, myristic acid, palmitic acid, myristoleic acid, palmitoleic acid, vaccenic acid, eicosenoic acid, propanoic acid, butanoic acid, pentanoic acid, hexanoic acid, heptanoic acid, octanoic acid, nonanoic acid, decanoic acid, dodecanoic acid, tetradecanoic acid, hexadecanoic acid, heptadecanoic acid, octadecanoic acid, nonadecanoic acid, icosanoic acid, and acetic acid; as well as dicarboxylic acids such as malonic acid, succinic acid, and adipic acid. However, there is no limitation thereto. Organic carboxylic acids and their salts are suitable organic compounds for the above-described manufacturing method.

Examples of organic nitrogen compounds are organic amines, organic amide compounds, and nitrogen-containing heterocyclic compounds.

The organic amine can be a primary amine, secondary amine, or tertiary amine. Primary and secondary amines are desirable. Aliphatic amines are an example, as are primary and secondary aliphatic amines. The number of carbon atoms of the amines is not specifically limited; examples are equal to or more than 5 but equal to or lower than 24, desirably equal to or more than 8 and equal to or lower than 20, preferably equal to or more than 12 but equal to or lower than 18. Specific examples of organic amines are alkylamines such as oleylamine, laurylamine, myristylamine, palmitylamine, stearylamine, octylamine, decylamine, dodecylamine, tetradecylamine, hexadecylamine, octadecylamine, and dioctylamine; aromatic amines such as aniline; hydroxyl group-comprising amines such as methylethanolamine and diethanolamine; and derivatives thereof.

Examples of nitrogen-containing heterocyclic compounds are saturated and unsaturated heterocyclic compounds having three to seven-membered rings with 1 to 4 nitrogen atoms. Hetero atoms in the form of sulfur atoms, oxygen atoms, and the like can be contained. Specific examples are pyridine, lutidine, cholidine, and quinolines.

Examples of organic sulfur compounds are organic sulfides, organic sulfoxides, and sulfur-containing heterocyclic compounds. Specific examples are dialkyl sulfides such as dibutyl sulfide; dialkyl sulfoxides such as dimethyl sulfoxide and dibutyl sulfoxide; and sulfur-containing heterocyclic compounds such as thiophene, thiolane, and thiomorpholine.

Examples of organic phosphorus compounds are phosphoric acid esters, phosphines, phosphine oxides, trialkyl phosphines, phosphorous acid esters, phosphonic acid esters, sub-phosphonic acid esters, phosphinic acid esters, and sub-phosphinic acid esters. Examples are tributyl phosphine, trihexyl phosphine, trioctyl phosphine, and other trialkyl phosphines; tributyl phosphine oxide, trihexyl phosphine oxide, trioctyl phosphine oxide (TOPO), tridecyl phosphine oxide, and other trialkyl phosphine oxides.

Examples of polymers and surfactants are polyethylene glycol, polyoxyethylene (1) lauryl ether phosphate, lauryl ether phosphate, sodium polyphosphate, sodium bis(2-ethylhexyl)sulfosuccinate, sodium dodecylbenzene sulfonate, polyacrylic acid and its salts, polymethacryic acid and its salts, polyvinyl alcohol, other hydroxyl group-comprising polymers, polyvinyl pyrrolidone, other nonionic polymers, and hydroxyethyl cellulose. Any from among cationic, anionic, and nonionic surfactants, as well as amphoteric surfactants, can be employed. Anionic surfactants are desirable.

The organic compound set forth above can be mixed with the precursor solution in the form of an organic compound solution added to solvent, or can be introduced into the feed passage to which high-temperature, high-pressure water is fed. The organic compound is desirably mixed in a quantity of about 1 to 1,000 weight parts per 100 weight parts of hexagonal ferrite precursor. Water or a water-miscible or hydrophilic organic solvent is desirable as the solvent. From this perspective, the use of an organic solvent in the form of a polar solvent is suitable. Examples of desirable organic solvents are the various solvents set forth above. The concentration of the organic compound in the organic compound solution can be set so that the above desirable quantity of organic compound is admixed or incorporated.

In the above manufacturing method, as set forth above, the pH of the water-based solution that has been discharged from the reaction flow passage and cooled in the cooling element is controlled to within a range of equal to or higher than 6.0 but equal to or lower than 12.0. Examples of means of achieving this are: to use an acidic compound as the organic compound; to use an alkaline compound as the organic compound; to mix a base, an acid, or a base and an acid, with the organic compound solution; and to determine the quantities added thereof so that the pH of the water-based solution that has been discharged from the reaction flow passage and cooled in the cooling element falls within the above-stated range. The term “acidic” as relates to the organic compound refers to one or more acids as defined by one or more among Arrhenius, Bronsted, or Lewis (Arrhenius acids, Bronsted acids, or Lewis acids). The term alkaline as regards the organic compound refers to one or more bases as defined by one or more among Arrhenius, Bronsted, or Lewis (Arrhenius bases, Bronsted bases, or Lewis bases). The base and the acid are as set forth above.

<Mixing the Precursor Solution, Organic Compound Solution, and High-Temperature, High-Pressure Water>

An example of an embodiment of mixing the precursor and the organic compound is to sequentially introduce the precursor solution and organic compound solution to the feed passage to which the high-temperature, high-pressure water is being fed. This embodiment will be referred to as Embodiment A, hereinafter.

An example of another embodiment is, once the precursor solution and organic compound solution have been mixed, introducing the mixed solution obtained to the feed passage to which the high-temperature, high-pressure water is being fed. This embodiment will be referred to as Embodiment B, hereinafter.

Embodiments A and B also include embodiments where preparation of the precursor solution is also conducted in a continuous manufacturing process.

These embodiments will be described below with reference to the drawings.

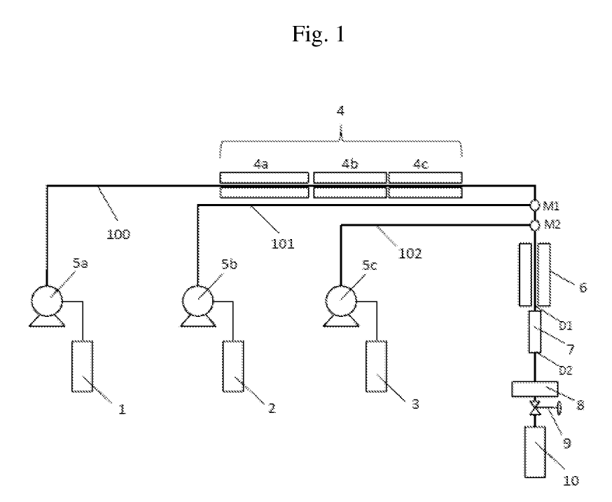

FIGS. 1 to 5 are schematic drawings descriptive of manufacturing devices that can be used to manufacture the hexagonal ferrite powder by continuously conducting a hydrothermal synthesis process (a continuous hydrothermal synthesis process).

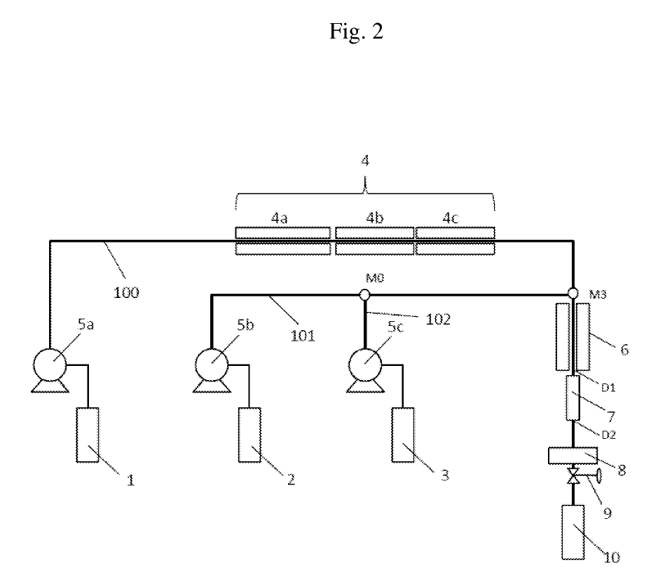

More specifically, FIG. 1 is a schematic descriptive drawing of an example of a manufacturing device suited to Embodiment A and FIG. 2 is a schematic descriptive drawing of an example of a manufacturing device suited to Embodiment B.

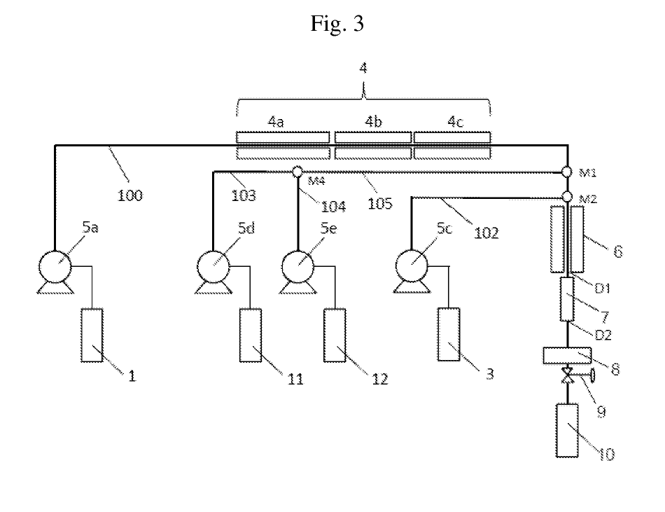

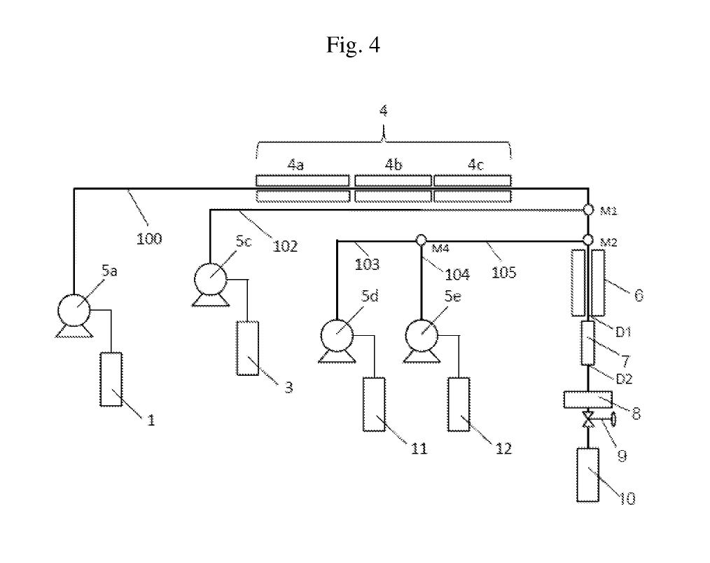

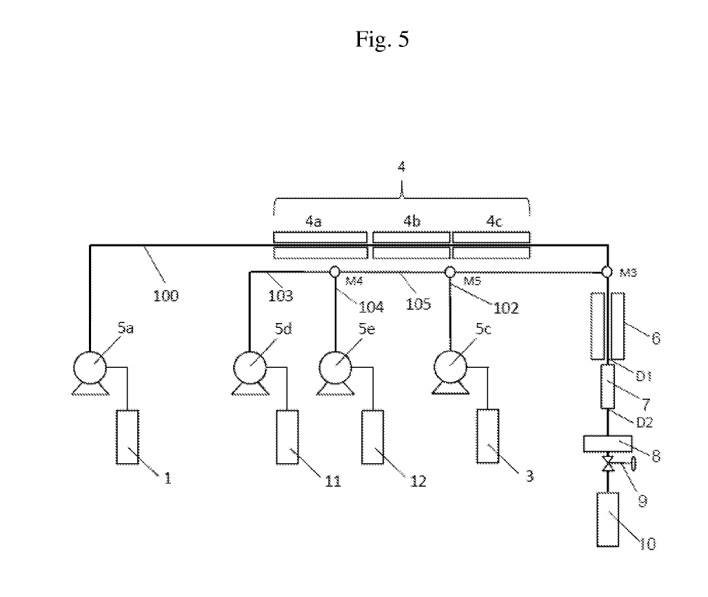

FIGS. 3 and 4 are schematic descriptive drawings of an example of a manufacturing device suited to an embodiment in which the preparation of the precursor solution is also conducted in a continuous manufacturing process. FIG. 5 is a schematic descriptive drawing of an example of a manufacturing device that is suited to an embodiment of Embodiment B in which preparation of the precursor solution is also conducted in a continuous manufacturing process.

In FIGS. 1 to 5, identical constituent elements are denoted by identical symbols.

Example of FIG. 1 will be described. The manufacturing device shown in FIG. 1 comprises liquid tanks 1, 2, and 3; heating means 4 (4a to 4c); pressurizing and feeding means 5a, 5b, and 5c; a reaction flow passage 6; a cooling element 7; a filtering means 8; a pressure-regulating valve (back pressure valve) 9; and a recovery element 10. Fluids are fed from the various liquid tanks to feed passage 100, flow passage 101, and flow passage 102. In the figure, three heating means are shown. However, this is just an example and not a limitation.

In an embodiment, water in the form of pure water, distilled water, or the like is introduced into liquid tank 1; hexagonal ferrite precursor solution is introduced into liquid tank 2; and organic compound solution is introduced into liquid tank 3. The water that has been introduced into liquid tank 1 is fed into feed passage 100 while being subjected to pressure by pressurizing and feeding means 5a, and is heated by heating means 4. The heating and pressurizing is done to put the water in a high-temperature, high-pressure state, and is desirably done to put the water in a subcritical to supercritical state. Since water in a subcritical to supercritical state can exhibit extremely high reactivity, contact with water in such a state instantaneously can place the hexagonal ferrite precursor in a highly reactive state, making it possible for the conversion to ferrite to take place early on. Generally, heating water to a temperature of equal to or higher than 200° C. and pressurizing it to a pressure of equal to or higher than 20 MPa will put it in a subcritical to supercritical state. Accordingly, this heating and pressurizing of the water is desirably conducted to a temperature of equal to or higher than 200° C. and a pressure of equal to or higher than 20 MPa. The high-temperature, high-pressure water that has been heated and pressurized is fed to feed passage 100 and arrives at mixing element M1.

In Embodiment A (FIG. 1), the hexagonal ferrite precursor solution is fed from liquid tank 2 by pressurizing and feeding means 5b to flow passage 101 and is converged in mixing element M1 with high-temperature, high-pressure water that is fed over feed passage 100. Subsequently, the mixed flow of high-temperature, high-pressure water and hexagonal ferrite precursor solution is converged in mixing element M2 with organic compound solution fed from flow passage 102 by pressurizing and feeding means 5c from liquid tank 3. Accordingly, in Embodiment A, the point of first contact where mixing of the hexagonal ferrite precursor solution and the organic compound begins in the above feed passage is mixing element M2. In Embodiment A, in contrast to the above-described example, organic compound solution can be introduced into liquid tank 2 and hexagonal ferrite precursor solution into liquid tank 3.

In Embodiment B (FIG. 2), hexagonal ferrite precursor solution is fed to flow passage 101 from liquid tank 2 by pressurizing and feeding means 5b, and converges in mixing element M0 with organic compound solution fed over flow passage 102 by pressurizing and feeding means 5c from tank 3. Subsequently, a mixed flow of hexagonal ferrite precursor solution and organic compound solution flows over flow passage 101 into mixing element M3, where it converges with high-temperature, high-pressure water. Accordingly, in Embodiment B, the point of first contact where mixing of hexagonal ferrite precursor solution and organic compound begins in the feed passage is mixing element M3. In contrast to the above example, in Embodiment B as well, it is possible to introduce organic compound solution to liquid tank 2 and hexagonal ferrite precursor solution to liquid tank 3.

The manufacturing devices shown in FIGS. 3 and 4 are suited to an embodiment in which hexagonal ferrite precursor solution is prepared as part of a continuous manufacturing process in Embodiment A. In the manufacturing devices shown in FIGS. 3 and 4, a solution containing an iron salt and a divalent metal salt (also referred to hereinafter as a “starting material solution”) is introduced into liquid tank 11 and a base-containing water-based solution (normally not containing an iron salt or a divalent metal salt) is introduced into liquid tank 12. Starting material solution that is fed from liquid tank 11 by pressurizing and feeding means 5d over pipe 103 and base-containing water-based solution that is fed from liquid tank 12 by pressurizing and feeding means 5e over pipe 104 are converged in mixing element M4. In contrast to the above example, it is also possible for base-containing water-based solution to be introduced into liquid tank 11 and starting material solution to be introduced into liquid tank 12.

In the manufacturing device shown in FIG. 3, the mixed flow thus obtained passes over flow passage 105, and is converged in mixing element M1 with high-temperature, high-pressure water that has been fed from liquid tank 1 by pressurizing and feeding means 5a to flow passage 100 and heated and by heating means 4. The mixed liquid thus obtained is converged in mixing element M2 with organic compound solution from liquid tank 3 that has been fed to feed passage 102 by pressurizing and feeding means 5c.

In the manufacturing device shown in FIG. 4, the mixed flow obtained as set forth above passes over flow passage 105, and in mixing element M2, is converged with a mixed flow that has been obtained in mixing element M1 by converging high-temperature, high-pressure water from liquid tank 1 that has been fed to flow passage 100 by pressurizing and feeding means 5a and heated by heating means 4 with organic compound solution from liquid tank 3 that has been fed to flow passage 102 by pressurizing and feeding means 5c.

In the manufacturing devices shown in FIGS. 3 and 4, the point of first contact where the mixing of hexagonal ferrite precursor solution and organic compound starts in the feed passage is mixing element M2.

The details of subsequent steps in the manufacturing devices shown in FIGS. 3 and 4 are as described above for the manufacturing device shown in FIG. 1.

The manufacturing device shown in FIG. 5 is suited to an embodiment in which the preparation of hexagonal ferrite precursor solution is also conducted in a continuous manufacturing process in Embodiment B. In the manufacturing device shown in FIG. 5, a solution containing an iron salt and a divalent metal salt (starting material solution) is introduced into liquid tank 11 and a base-containing water-based solution (normally not containing either iron salt or divalent metal salt) is introduced into liquid tank 12. The starting material solution that has been fed from liquid tank 11 by pressurizing and feeding means 5d to pipe 103 and the base-containing water-based solution that has been fed from liquid tank 12 by pressurizing and feeding means 5e to pipe 104 are converged in mixing element M4. In contrast to the above example, it is also possible for base-containing water-based solution to be introduced into liquid tank 11 and starting material solution to be introduced to liquid tank 12.

The mixed liquid thus obtained is then converged in mixing element M5 of flow passage 105 with organic compound solution that has been fed over pipe 102 by pressurizing and feeding means 5c from liquid tank 3. The mixed liquid thus obtained is then further converged in mixing element M3 with high-temperature, high-pressure water that has been fed to flow passage 100 by pressurizing and feeding means 5a from liquid tank 1 and heated by heating means 4. In the manufacturing device shown in FIG. 5, the point of first contact where mixing of hexagonal ferrite precursor solution begins in the feed passage is mixing element M3.

The details of the subsequent steps are identical to those described for the manufacturing device shown in FIG. 2 above.

In the above manufacturing methods, the solution temperature at the above-mentioned point of first contact is kept at equal to or higher than 200° C. but lower than 300° C. A magnetic layer containing ferromagnetic powder in the form of hexagonal ferrite powder prepared at a pH of the water-based solution following cooling, described further below, and at a solution temperature at the first contact point of equal to or higher than 200° C. but lower than 300° C. can exhibit high coating durability. A magnetic recording medium in which such a magnetic layer is present can exhibit good electromagnetic characteristics. In this regard, the present inventor presumes that the particle size, uniformity of the particle size, and shape of the particles can impact the electromagnetic characteristics and coating durability. The fact that keeping the above solution temperature at equal to or higher than 200° C. can allow the reaction converting the hexagonal ferrite precursor to hexagonal ferrite to rapidly start and progress in the presence of an organic compound is thought by the present inventor to contribute to obtain hexagonal ferrite powder of small particle size and with little variation in particle size. The present inventor also presumes that getting the reaction to progress early on may reduce the isotropy of the particle shape of the hexagonal ferrite powder obtained. By contrast, keeping the above solution temperature at lower than 300° C. is thought to contribute to obtain hexagonal ferrite powder having an isotropic particle shape. From these perspectives, the solution temperature at the point of first contact is desirably equal to or higher than 210° C., preferably equal to or higher than 220° C., and desirably equal to or lower than 295° C., and preferably, equal to or lower than 290° C.

The temperature at the point of first contact can be controlled by, for example, controlling the temperature of the solution that is fed to the point of first contact. To that end, for example, it is possible to provide at any position within the device a known temperature control means for heating and cooling the solutions that are fed to flow passages 101, 102, 103, 104, and 105. In Embodiment A, in which the flow passage of hexagonal ferrite precursor solution and the flow passage of organic compound solution are converged, the mixed liquid obtained is introduced to a feed passage to which high-temperature, high-pressure water is flowing. From the perspective of obtaining hexagonal ferrite powder with little variation in particle size, the mixed liquid is desirably not heated following converging of the flow passage of hexagonal ferrite precursor solution and the flow passage of the organic compound solution. Accordingly, in the above embodiments, if the hexagonal ferrite precursor solution is heated, the heating is desirably conducted prior to converging the organic compound solution. For example, in one desirable embodiment, a heating means can be provided to the upstream side of mixing element M0 of flow passage 101 in the manufacturing device shown in FIG. 1. In that case, a cooling means can also be provided to the downstream side of mixing element M0. It then suffices to conduct the heating and cooling of individual solutions in such a manner that the solution temperature at the point of first contact is equal to or higher than 200° C. but lower than 300° C.

The temperature at the point of first contact can also be controlled by adjusting one or more from among the temperature and flow rate of the high-temperature, high-pressure water; the flow rate of the hexagonal ferrite precursor solution; the flow rate of the organic compound solution; and the flow rate of the mixed flow obtained by combining the hexagonal ferrite precursor solution and the organic compound solution. It suffices to effect this adjustment so that the solution temperature at the point of first contact is kept to equal to or higher than 200° C. but lower than 300° C. As an example, the solution temperature of the solutions and mixed flow normally differs from (is normally lower than) the temperature of the high-temperature, high-pressure water that is fed to the feed passage. Thus, it is possible to control the temperature at the point of first contact by varying the ratio of the flow rate of the mixed flow, the solutions that are introduced to the feed passage, and the flow rate of the high-temperature, high-pressure water.

Following mixing in the above mixing elements, the mixed flow of high-temperature, high-pressure water, hexagonal ferrite precursor, and organic compound (the water-based solution containing hexagonal ferrite precursor, organic compound, and water) is fed through feed passage 100 to the reaction flow passage 6. In reaction flow passage 6, the mixed flow is heated as well as being pressurized by pressurizing means 5a to place the water contained in the mixed flow in reaction flow passage 6 in a state of high temperature and high pressure, desirably in a subcritical to supercritical state, so that conversion of the hexagonal ferrite precursor to ferrite can advance. Subsequently, solution in which hexagonal ferrite precursor has been converted to ferrite and thus containing particles of hexagonal ferrite is discharged through discharge outlet D1. The discharged solution is fed to cooling element 7 and cooled in cooling element 7. Subsequently, the hexagonal ferrite particles are captured by a filtering means (filter or the like) 8. The hexagonal ferrite particles that have been captured by filtering means 8 are released by filtering means 8, pass through pressure-regulating valve 9, and are recovered in recovery element 10.

Regarding the heating and pressurizingin reaction flow passage 6, the reaction system in which water is present is heated to equal to or higher than 300° C. and pressurized to a pressure of equal to or higher than 20 MPa to put the water in a subcritical to supercritical state, creating a reaction field of extremely high reactivity. Placing the hexagonal ferrite precursor in this state can cause ferrite conversion to advance rapidly, yielding hexagonal ferrite magnetic particles. Accordingly, the heating temperature is desirably a temperature at which the mixed flow in the reaction flow passage reaches equal to or higher than 300° C. The heating temperature is preferably set so that the temperature of the water-based solution that is discharged from the reaction flow passage and fed to the cooling element reaches equal to or higher than 350° C. but equal to or lower than 450° C. Here, the solution temperature refers to the solution temperature at the discharge outlet of the reaction flow passage (discharge outlet D1 in the devices shown in FIGS. 1 and 2). Conducting the reaction that converts the hexagonal ferrite precursor in the reaction flow passage into hexagonal ferrite under temperature conditions such that the solution temperature at the discharge outlet of the reaction flow passage falls within the above-stated range is desirable from the perspective of enhancing the magnetic characteristics of the hexagonal ferrite powder obtained. This has been presumed by the present inventor to occur because of improved crystallinity of the hexagonal ferrite powder. The solution temperature is preferably equal to or higher than 360° C. but equal to or lower than 430° C., more preferably equal to or higher than 380° C. but equal to or lower than 420° C. The pressure that is applied to the mixed flow in the reaction flow passage is desirably equal to or higher than 20 MPa, preferably falling within a range of 20 to 50 MPa.

As set forth above, the water-based solution that has been discharged from the reaction flow passage is cooled in the cooling element. This cooling in the cooling element can completely halt the reaction that converts hexagonal ferrite precursor into hexagonal ferrite. This is desirable to obtain hexagonal ferrite powder with little variation in particle size. For this reason, the cooling in the cooling element is desirably conducted to a temperature of the water-based solution within the cooling element of equal to or lower than 100° C., and preferably conducted to equal to or higher than room temperature (about 20 to 25° C.) but equal to or lower than 100° C. The cooling can be conducted using a known cooling means such as a water-cooling device the interior of which is cooled by circulating cold water. The same pressure as that applied in the feed passage and reaction flow passage is normally applied to the water-based solution in the cooling element.

In the above manufacturing method, the pH of the water-based solution following cooling in the cooling element is equal to or higher than 6.0 but equal to or lower than 12.0. The “pH . . . following cooling” referred to here is the pH of the water-based solution that has been discharged through the discharge outlet (discharge outlet D2 in FIGS. 1 and 2) of the cooling element, as set forth above. This pH can be measured by collecting a portion of the water-based solution recovered in recovery element 10 after passing through pressure-regulating valve 9, and adjusting the solution temperature to 25° C. The components that cause the pH of the water-based solution to change in the cooling element are normally not added. Accordingly, the pH of the water-based solution following cooling is either the same as the pH of the reaction system in the reaction flow passage in which the reaction that converts the hexagonal ferrite precursor to hexagonal ferrite is conducted, or is correlated to it. The above described means of controlling the pH can be used to control the pH of the water-based solution following cooling. In a reaction system in which the pH reaches equal to or higher than 6.0, hexagonal ferrite can be readily generated. However, at a pH of lower than 6.0, the generation of hematite (Fe₂O₃) may take precedence over the generation of hexagonal ferrite, and it becomes difficult to obtain particles exhibiting the crystal structure of hexagonal ferrite. Conversely, when the pH exceeds 12.0, a magnetic layer containing ferromagnetic powder in the form of the hexagonal ferrite powder obtained will exhibit poor coating durability and a magnetic recording medium in which such a magnetic layer is present will exhibit poor electromagnetic characteristics. The present inventor presume this to be due to the fact that the reaction that converts hexagonal ferrite precursor to hexagonal ferrite progresses excessively quickly, compromising the isotropy of the particles that are obtained. From the perspective of obtaining isotropic particles, the pH is desirably equal to or lower than 11.5, preferably equal to or lower than 11.0. From the perspectives of readily generating hexagonal ferrite and obtaining small particles of hexagonal ferrite with little variation in particle size, the pH is desirably equal to or higher than 6.5.

In the manufacturing method set forth above, it is desirable to employ high pressure-use metal piping as the feed passages and flow passages (also referred to as “piping” hereinafter) to apply pressure to the fluids that are fed through the interior. The metal constituting the piping is desirably SUS316, SUS 304, or some other stainless steel, or a nickel-based alloy such as Inconel (Japanese registered trademark) or Hastelloy (Japanese registered trademark) because of their low-corrosion properties. However, there is no limitation thereto. Equivalent or similar materials can also be employed. The piping of laminate structure described in Japanese Unexamined Patent Publication (KOKAI) No. 2010-104928, which is expressly incorporated herein by reference in its entirety, can also be employed.

In the manufacturing devices shown in FIGS. 1 and 2, the various mixing elements have structures such that pipes are joined by T-joints. The reactors described in Japanese Unexamined Patent Publication (KOKAI) Nos. 2007-268503, 2008-12453, 2010-75914, and the like, which are expressly incorporated herein by reference in their entirety, can be employed as the mixing elements. The material of the reactor is desirably the material described in Japanese Unexamined Patent Publication (KOKAI) No. 2007-268503, 2008-12453, or 2010-75914, which are expressly incorporated herein by reference in their entirety. Specifically, the metals set forth above as being suitable for constituting piping are desirable. However, there is no limitation thereto, and equivalent or similar materials can be employed. Combination with low-corrosion titanium alloys, tantalum alloy, ceramics and the like is also possible.

A number of specific embodiments of methods of manufacturing hexagonal ferrite powder according to an aspect of the present invention have been described. However, the above manufacturing methods are not limited by these specific embodiments.

### Hexagonal Ferrite Powder

A further aspect of the present invention relates to hexagonal ferrite powder manufactured by the above manufacturing method.

The above manufacturing method can yield hexagonal ferrite powder that can be suitably used in the fabrication of magnetic recording media having a magnetic layer with good coating durability and exhibiting good electromagnetic characteristics by a hydrothermal synthesis process. As set forth above, the present inventor presume that obtaining hexagonal ferrite powder of small particle size and little variation in particle size can contribute to enhancing the coating durability of the magnetic layer and the electromagnetic characteristics of magnetic recording media. The hexagonal ferrite powder is desirably fine particles with an average particle size of equal to or lower than 30 nm. The average particle size is preferably equal to or lower than 25 nm, more preferably equal to or lower than 20 nm. From the perspective of the stability of magnetization, the average particle size is desirably equal to or higher than 10 nm, preferably equal to or higher than 12 nm. The coefficient of variation in the particle size is desirably equal to or lower than 25%, preferably equal to or higher than 20%. The coefficient of variation in particle size can be, for example, equal to or higher than 10% or equal to or more higher 15%. However, the smaller it is, the more desirable it becomes.

The particle shape of the hexagonal ferrite powder is not specifically limited. As set forth above, the above manufacturing method can yield particles having an isotropic shape (isotropic particles). The term “isotropic” as relates to particles in the present invention means particles that are not tabular. The term isotropic includes elliptical, spherical, octahedral, and infinite shapes. The term “tabular” refers to a shape having a main surface. The term “main surface” refers to the outer surface accounting for the greatest area on the particle. An example of the shape of tabular hexagonal ferrite particles is a hexagonal flat shape. In a hexagonal flat shape, the surface that accounts for the greatest area is the outer surface of hexagonal shape. That portion is called the main surface. In the above hexagonal ferrite powder, among 500 particles the particle size of which is measured by the method set forth above, the ratio accounted for by isotropic particles is desirably equal to or more than 80%, preferably equal to or more than 85% based on the number of particles. The ratio accounted for by isotropic particles can be 100%, or can be equal to or less than 99%, equal to or less than 98%, or equal to or less than 96%.

The isotropic particles desirably have a ratio of major axis length to minor axis length (major axis length/minor axis length), as determined by the method set forth above, of equal to or less than 2, preferably equal to or less than 1.5. This ratio of isotropic particles (major axis length/minor axis length) is desirably equal to or more than 1.0, preferably equal to or more than 1.2. When particles of equal to or more than 1.2 but less than 2 are defined as spherical particles, among 500 particles the particle size of which has been measured by the method set forth above, the ratio accounted for by spherical particles among isotropic particles is desirably equal to or more than 80%, preferably equal to or more than 85% based on number of particles. The ratio accounted for by spherical particles can be 100%, or can be equal to or less than 99%, equal to or less than 98%, or equal to or less than 96%.

### Magnetic Recording Medium

A further aspect of the present invention relates to a magnetic recording medium which comprises a magnetic layer comprising ferromagnetic powder and binder on a nonmagnetic support, wherein the ferromagnetic powder is the above hexagonal ferrite powder. Using the hexagonal ferrite powder according to an aspect of the present invention as ferromagnetic powder makes it possible to form a magnetic layer of high coating durability, and to obtain a magnetic recording medium exhibiting good electromagnetic characteristics. This point was discovered by the present inventor.

The magnetic recording medium according to an aspect of the present invention will be described in greater detail below.

Magnetic Layer

Details of the ferromagnetic powder that is employed in the magnetic layer, and of the method of manufacturing it, are as set forth above.

The magnetic layer contains ferromagnetic powder and binder. Polyurethane resins, polyester resins, polyamide resins, vinyl chloride resins, acrylic resins such as those provided by copolymerizing styrene, acrylonitrile, methyl methacrylate and the like, cellulose resins such as nitrocellulose, epoxy resins, phenoxy resins, polyvinylacetal, polyvinylbutyral, and other polyvinyl alkylal resins can be employed singly, or as mixtures of multiple resins, as the binder contained in the magnetic layer. Among these, desirable resins are polyurethane resin, acrylic resins, cellulose resins, and vinyl chloride resins. These resins can also be employed as binders in the nonmagnetic layer described further below. Reference can be made to paragraphs 0029 to 0031 of Japanese Unexamined Patent Publication (KOKAI) No. 2010-24113, which is expressly incorporated herein by reference in its entirety, with regard to the above binders. Polyisocyanate curing agents can also be employed with the above resins.

Additives can be added as needed to the magnetic layer. Examples of additives are abrasives, lubricants, dispersing agents, dispersion adjuvants, antifungal agents, antistatic agents, oxidation inhibitors, solvents, and carbon black. The additives set forth above can be suitably selected for use from among commercial products based on the properties desired.

Nonmagnetic Layer

The contents of the nonmagnetic layer will be described in detail next. The magnetic recording medium of an aspect of the present invention can comprise a nonmagnetic layer containing nonmagnetic powder and binder between the nonmagnetic support and the magnetic layer. The nonmagnetic powder that is employed in the nonmagnetic layer can be an organic or an inorganic material. Carbon black and the like can also be employed. Examples of inorganic materials are metals, metal oxides, metal carbonates, metal sulfates, metal nitrides, metal carbides, and metal sulfides. Nonmagnetic powders of these materials are available as commercial products and can be manufactured by known methods. For details, reference can be made to Japanese Unexamined Patent Publication (KOKAI) No. 2010-24113, paragraphs 0036 to 0039.

The binders, lubricants, dispersing agents, additives, solvents, dispersion methods, and the like of the magnetic layer are also suitable for use for the nonmagnetic layer. Techniques that are known for magnetic layers can also be applied to the quantity and type of binder, the quantities and types of additives and dispersing agents added, and the like. Carbon black and organic material powders can also be added to the nonmagnetic layer. In this regard, by way of example, reference can be made to Japanese Unexamined Patent Publication (KOKAI) No. 2010-24113, paragraphs 0040 to 0042.

Nonmagnetic Support

Examples of nonmagnetic supports are known supports such as biaxially stretched polyethylene terephthalate, polyethylene naphthalate, polyamide, polyamide-imide, and aromatic polyamide. Among these, polyethylene terephthalate, polyethylene naphthalate, and polyamide are desirable.

These supports can be subjected in advance to corona discharge, plasma treatment, adhesion-enhancing treatment, heat treatment, or the like. The surface roughness of a nonmagnetic support that is suited to use in the present invention is desirably a center average roughness Ra of 3 nm to 10 nm at a cutoff value of 0.25 mm.

Layer Structure

In the thickness structure of the magnetic recording medium according to an aspect of the present invention, the thickness of the nonmagnetic support is desirably 3 μm to 80 μm. The thickness of the magnetic layer can be optimized based on the amount of saturation magnetization of the magnetic head employed, the length of the head gap, and the bandwidth of the recording signal. Generally, it can be 0.01 μm to 0.15 μm, desirably 0.02 μm to 0.12 μm, and preferably, 0.03 μm to 0.10 μm. It suffices for the magnetic layer to be comprised of a least one layer, but it can separated into two or more layers having different magnetic characteristics. The structures of known multilayer magnetic layers can be applied.

The thickness of the nonmagnetic layer is for example 0.1 μm to 3.0 μm, desirably 0.3 μm to 2.0 μm, and preferably 0.5 μm to 1.5 μm. The nonmagnetic layer of a magnetic recording medium according to an aspect of the present invention includes an essentially nonmagnetic layer containing trace quantities of ferromagnetic powder, for example, either as impurities or intentionally, in addition to the nonmagnetic powder. The essentially nonmagnetic layer means a layer exhibiting a residual magnetic flux density of equal to or less than 10 mT, a coercive force of equal to or less than 7.96 kA/m (100 Oe), or a residual magnetic flux density of equal to or less than 10 mT and a coercive force of equal to or less than 7.96 kA/m (100 Oe). The nonmagnetic desirably has no residual magnetic flux density or coercive force.

Backcoat Layer

A backcoat layer can be provided on the opposite surface of the nonmagnetic support from that on which the magnetic layer is present in the magnetic recording medium. The backcoat layer desirably comprises carbon black and inorganic powder. The formula of the magnetic layer and nonmagnetic layer can be applied to the binder and various additives used to form the backcoat layer. The thickness of the back coat layer is desirably equal to or less than 0.9 μm, preferably 0.1 μm to 0.7 μm.

Manufacturing Method

The process of manufacturing the coating liquid for forming the magnetic layer, nonmagnetic layer, or backcoat layer normally comprises at least a kneading step, dispersing step, and mixing steps provided as needed before and after these steps. The various steps can each be divided into two or more steps. All of the starting materials employed in the present invention, such as ferromagnetic powder, nonmagnetic powder, binder, carbon black, abrasives, antistatic agents, lubricants, and solvents, can be added either initially during the step or part way through. Any individual starting material can be divided for addition in two or more steps. For example, polyurethane can be divided up and added during a kneading step, dispersing step, or mixing step following dispersion to adjust the viscosity. In an aspect of the present invention, conventionally known manufacturing techniques can be employed for some of the steps. In the kneading step, it is desirable to employ an apparatus with powerful kneading strength in the kneading step, such as an open kneader, continuous kneader, pressurizing kneader, or extruder. Details on these kneading treatments are described in Japanese Unexamined Patent Publication (KOKAI) Heisei No. 1-106338 and Heisei No. 1-79274, which are expressly incorporated herein by reference in their entirety. Glass beads can also be used to disperse the magnetic layer coating liquid, nonmagnetic layer coating liquid, or backcoat layer coating liquid. High specific gravity dispersing beads in the form of zirconia beads, titania beads, and steel beads are also suitable. The particle diameter and packing rate of these dispersing beads can be optimized for use. A known dispersing apparatus can be employed. For details on methods of manufacturing magnetic recording media, reference can be made to Japanese Unexamined Patent Publication (KOKAI) No. 2010-24113, paragraphs 0051 to 0057, for example.

The magnetic recording medium according to an aspect of the present invention set forth above has a magnetic layer containing the above-described hexagonal ferrite powder, and thus can exhibit good electromagnetic characteristics and good running durability. Thus, it is suitable as a large-capacity magnetic recording medium such as a backup tape.

### EXAMPLES

The present invention will be described in greater detail below through Examples. However, the present invention is not limited to the embodiments shown in Examples. The “parts” and “percent” indicated below denote “weight parts” and “weight percent,” respectively. Unless specifically stated otherwise, the steps and evaluations set forth below were conducted in air at 23° C.±1° C.

### 1. Examples and Comparative Examples Relating to the Manufacturing of Hexagonal Ferrite Powder

### Example 1-1

### (1) Preparation of Precursor-Containing Water-Based Solution

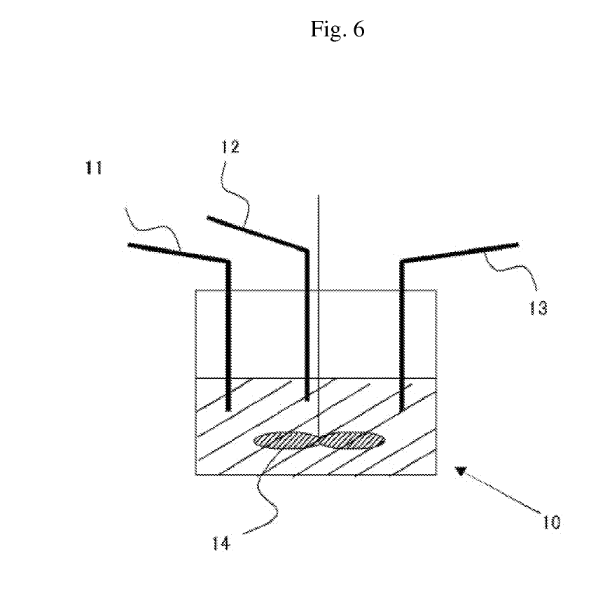

A precursor-containing water-based solution was prepared by the following method with the batch-type reaction tank 10 schematically rendered in FIG. 6. In the following steps, heating controls were effected by means of a heater to maintain a solution temperature in the reaction tank of 30° C. During the period from the start to the end of feeding the water-based solution given below, stirring was continuously conducted with stirring vanes 14.

To pure water filling reaction tank 10 were added 4.0 g of iron (III) nitrate nonahydrate (Fe(NO₃)₃.9H₂O) per 100 g of pure water and the mixture was stirred at a solution temperature of 30° C. To the water-based solution thus prepared was fed at a constant rate (flow rate 7.5 mL/min) over feed passage 13 a potassium hydroxide water-based solution with a concentration of 1 mol/L. When feeding of the potassium hydroxide water-based solution had ended, a potassium hydroxide water-based solution prepared by adding 1.6 g of barium hydroxide octahydrate (Ba(OH)₂.8H₂O) per 100 g of pure water was fed at a constant flow rate (flow rate 25 mL/min) over feed passage 11 to prepare a precursor-containing water-based solution.

(2) Synthesis of Hexagonal Ferrite (Barium Ferrite Nanoparticles) by a Continuous Hydrothermal Synthesis Process

The aqueous solution (sol) prepared in (1) above was introduced into liquid tank 2 of the manufacturing device shown in FIG. 1. SUS316BA tube was employed as the piping in the manufacturing device.

While using a high-pressure pump 5a to feed the pure water that had been introduced into liquid tank 1, it was heated by a heater 4 and high-temperature, high-pressure water was caused to flow through feed passage 100. In this process, the temperature and pressure were controlled such that the temperature of the high-temperature, high-pressure water after passing through heating means 4c was 345° C. and the pressure was 30 MPa.

The aqueous solution (sol) that had been introduced into liquid tank 2 was fed at 25° C. to flow passage 101 with a high-pressure pump 5b and mixed with high-temperature, high-pressure water in mixing element M1. Next, the organic compound solution that had been introduced into liquid tank 3 was fed with high-pressure pump 5c to flow passage 102 at 25° C. and converged with the mixed flow of aqueous solution (sol) and high-temperature, high-pressure water in mixing element M2. The solution temperature in mixing element M2 was measured with a thermocouple. A solution of oleic acid dissolved in ethanol (concentration 0.75 mol/L) was employed as the organic compound solution. The mixed flow obtained by converging the organic compound solution was heated and pressurized in reaction flow passage 6 to synthesize hexagonal ferrite (convert the precursor). The mixed flow in reaction flow passage 6 was pressurized to 30 MPa and heated to a temperature of equal to or higher than 300° C. such that the temperature of the solution (as measured by thermocouple) at discharge outlet D1 of reaction flow passage 6 was 400° C.

Subsequently, the solution containing hexagonal ferrite was discharged over reaction flow passage 6, cooled to equal to or lower than 100° C. in cooling element 7 equipped with a water-cooling mechanism, passed through pressure-regulating valve 9, and was recovered in recovering element 10. A portion of the solution that was recovered was collected and adjusted to a solution temperature of 25° C. The pH was then measured with a pH meter (portable pH meter, D series, made by Horiba). Hexagonal ferrite particles were collected from the remainder of the solution recovered from the recovery element. The collected particles were washed with ethanol and then centrifuged to separate the powder.

### Example 1-2

The temperature setting of heater 4 was adjusted to lower the temperature of the high-temperature, high-pressure water fed to feed passage 100 to within a range of equal to or higher than 200° C. As a result, the temperature in mixing element M2 became the value indicated in Table 1.

The remainder was implemented in the same manner as in Example 1-1.

### Example 1-3

The organic compound solution was changed to potassium oleate aqueous solution (concentration 0.75 mol/L) and the pH of the potassium oleate aqueous solution was adjusted by adding potassium hydroxide. As a result, the pH of the solution that was recovered from the recovery element became the value indicated in Table 1.

The remainder was implemented in the same manner as in Example 1-1.

### Example 1-4

The temperature setting of heater 4 was adjusted to lower the temperature of the high-temperature, high-pressure water fed to feed passage 100 to within a range of equal to or higher than 200° C. As a result, the temperature in mixing element M2 became the value indicated in Table 1.

The remainder was implemented in the same manner as in Example 1-3.

### Example 1-5

With the exception that heating was conducted so that the solution temperature (as measured by thermocouple) became 360° C. at the discharge outlet D1 of reaction flow passage 6, the same process was implemented as in Example 1-1.

### Comparative Example 1-1

The temperature setting of heater 4 was adjusted to raise the temperature of the high-temperature, high-pressure water fed to feed passage 100. As a result, the temperature in mixing element M2 became the value indicated in Table 1.

The remainder was implemented in the same manner as in Example 1-1.

### Comparative Example 1-2

The quantity of potassium hydroxide aqueous solution added to the precursor-containing solution was decreased below that in Example 1-1. As a result, the pH of the solution recovered in the recovery element became the value indicated in Table 1.

The remainder was implemented in the same manner as in Example 1-1.

### Comparative Example 1-3

The organic compound water-based solution was changed to potassium oleate aqueous solution (concentration 0.75 mol/L) and the pH of the potassium oleate aqueous solution was adjusted by adding potassium hydroxide. As a result, the pH of the solution recovered in the recovery element became the value indicated in Table 1.

The remainder was implemented in the same manner as in Example 1-1.

### Comparative Example 1-4

The temperature setting of heater 4 was adjusted to raise the temperature of the high-temperature, high-pressure water fed to feed passage 100. As a result, the temperature in mixing element M2 became the value indicated in Table 1.

The remainder was implemented in the same manner as in Comparative Example 1-3.

Evaluation Methods

### (1) Identification by X-Ray Diffraction Analysis

When the powders obtained in Examples and Comparative Examples were subjected to X-ray diffraction analysis, Examples 1-1 to 1-5 and Comparative Examples 1-1, 1-3, and 1-4 were determined to be hexagonal ferrite (barium ferrite). Comparative Example 1-2 was determined to be hematite (Fe₂O₃).

### (2) Average Particle Size (Average Major Axis Length) and Coefficient of Variation in Particle Size

The average particle size (average major axis length) and coefficient of variation in particle size (major axis length) of the powders obtained in Examples and Comparative Examples were obtained by the methods set forth above with an electron microscope in the form of a model H-9000 transmission electron microscope made by Hitachi.

### (3) Observation of Particle Shape

The shape of 500 particles extracted randomly from the powders prepared in Examples and Comparative Examples was observed the method set forth above and the ratio accounted for by spherical particles among all particles was calculated.

The results of the above are given in Table 1.

TABLE 1

| | Example s | | | | | Comparative Examples | | | |
|---|---|---|---|---|---|---|---|---|---|
| | 1-1 | 1-2 | 1-3 | 1-4 | 1-5 | 1-1 | 1-2 | 1-3 | 1-4 |
| Solution | 290° C. | 220° C. | 290° C. | 220° C. | 290° C. | 320° C. | 290° C. | 290° C. | 175° C. |
| temperature in | | | | | | | | | |
| mixing element | | | | | | | | | |
| M2 | | | | | | | | | |
| pH following | 6.9 | 6.7 | 11.3 | 11.4 | 6.8 | 6.9 | 5.3 | 12.5 | 11.7 |
| cooling | | | | | | | | | |
| Solution | 400° C. | 400° C. | 400° C. | 400° C. | 360° C. | 400° C. | 400° C. | 400° C. | 400° C. |
| temperature at | | | | | | | | | |
| discharge outlet of | | | | | | | | | |
| reaction flow | | | | | | | | | |
| passage | | | | | | | | | |
| Organic | Oleic acid | Oleic acid | Potassium | Potassium | Oleic acid | Oleic acid | Oleic acid | Potassium | Potassium |
| compound | | | oleate | oleate | | | | oleate | oleate |
| Average major | 18 nm | 15 nm | 20 nm | 19 nm | 14 nm | 22 nm | 32 nm | 35 nm | 40 nm |
| axis length | | | | | | | | | |
| Coefficient of | 19% | 20% | 22% | 23% | 20% | 23% | 29% | 27% | 35% |
| variation in major | | | | | | | | | |
| axis length | | | | | | | | | |
| Ratio accounted | 87% | 93% | 81% | 89% | 95% | 40% | 55% | 62% | 78% |
| for by spherical | | | | | | | | | |
| particles among all | | | | | | | | | |
| particles (particle | | | | | | | | | |
| number ratio) | | | | | | | | | |
| Results of | Barium | Barium | Barium | Barium | Barium | Barium | Hematite | Barium | Barium |
| identification by | ferrite | ferrite | ferrite | ferrite | ferrite | ferrite | (Fe₂O₃) | ferrite | ferrite |
| X-ray diffraction | | | | | | | | | |
| analysis | | | | | | | | | |

The barium ferrite powder prepared in the above Examples and Comparative Examples was employed in the following Examples and Comparative Examples relating to magnetic recording media. Since the powder prepared in Comparative Example 1-2 was hematite, it was not used to fabricate magnetic tape.

### 2. Examples and Comparative Examples Relating to Magnetic Recording Media (Magnetic Tape)

### Examples 2-1 to 2-5

### Comparative Examples 2-1 to 2-3

### (1) Formula of Magnetic Layer Coating Liquid

### (Magnetic Liquid)

Ferromagnetic powder (powder obtained in above Example or Comparative Example, listed in Table 2): 100 parts
SO₃Na group-containing polyurethane resin: 14 parts

(weight average molecular weight: 70,000, SO₃Na groups: 0.4 meq/g)

Cyclohexanone: 150 parts
Methyl ethyl ketone: 150 parts

### (Abrasive Liquid)

Abrasive liquid A Alumina abrasive (average particle size: 100 nm): 3 parts
Sulfonic acid group-containing polyurethane resin: 0.3 part

(weight average molecular weight: 70,000, SO₃Na groups: 0.3 meq/g)

Cyclohexanone: 26.7 parts
Abrasive liquid B Diamond abrasive (average particle size: 100 nm): 1 part
Sulfonic acid group-containing polyurethane resin: 0.1 part

(weight average molecular weight: 70,000, SO₃Na groups: 0.3 meq/g)

Cyclohexanone: 26.7 parts

### (Silica Sol)

Colloidal silica (average particle size: 100 nm): 0.2 part
Methyl ethyl ketone: 1.4 parts

### (Other Components)

Stearic acid: 2 parts
Butyl stearate: 6 parts
Polyisocyanate (Coronate made by Nippon Polyurethane Industry Co., Ltd.): 2.5 parts

### (Solvent Added to Finish)

Cyclohexanone: 200 parts
Methyl ethyl ketone: 200 parts

### (2) Formula of Nonmagnetic Layer Coating Liquid

Nonmagnetic inorganic powder α-iron oxide: 100 parts

Average particle size: 10 nm

Average acicular ratio: 1.9

BET specific surface area: 75 m²/g

Carbon black (average particle size: 20 nm): 25 parts
SO₃Na group-containing polyurethane resin: 18 parts

(weight average molecular weight: 70,000, SO₃Na groups: 0.2 meq/g)

Stearic acid: 1 part
Cyclohexanone: 300 parts
Methyl ethyl ketone: 300 parts

### (3) Formula of Backcoat Layer Coating Liquid

Nonmagnetic inorganic powder α-iron oxide: 80 parts

Average particle size: 0.15 μm

Average acicular ratio: 7

BET specific surface area: 52 m²/g

Carbon black (average particle size: 20 nm): 20 parts
Vinyl chloride copolymer: 13 parts
Sulfonic acid group-comprising polyurethane resin: 6 parts
Phenylphosphonic acid: 3 parts
Cyclohexanone: 155 parts
Methyl ethyl ketone: 155 parts
Stearic acid: 3 parts
Butyl stearate: 3 parts
Polyisocyanate: 5 parts
Cyclohexanone: 200 parts

### (3) Fabrication of Magnetic Tape

The above magnetic powder was dispersed for 24 hours with a batch-type vertical sand mill. A dispersing medium in the form of 0.5 mm Φ zirconia beads was employed. The abrasive liquid was dispersed for 24 hours in a batch-type ultrasonic device (20 kHz, 300 W). These dispersions were added to the other components (silica sol, other components, and solvents added to finish) and then processed for 30 minutes in a batch-type ultrasonic device (20 kHz, 300 W). Subsequently, filtering was conducted with a filter having an average pore size of 0.5 μm to prepare a magnetic layer coating liquid.

For the nonmagnetic layer coating liquid, the various components were dispersed for 24 hours in a batch-type vertical sand mill. A dispersing medium in the form of 0.1 mm Φ zirconia beads was employed. The dispersion obtained was filtered with a filter having an average pore size of 0.5 μm to prepare a nonmagnetic layer coating liquid.

For the backcoat layer coating liquid, the various components excluding the lubricants (stearic acid and butyl stearate), the polyisocyanate, and 200 parts of cyclohexanone were kneaded and diluted in an open kneader, and subjected to 12 passes of dispersion processing in a horizontal bead mill disperser using 1 mm Φ zirconia beads at a bead fill rate of 80%, a rotor tip circumferential speed of 10 m/s with a single-pass retention time of 2 minutes. Subsequently, the remaining components were added to the dispersion and stirred with a dissolver. The dispersion obtained was filtered with a filter having a mean pore size of 1 μm to prepare a backcoat layer coating liquid.

Subsequently, the nonmagnetic layer coating liquid was coated and dried to a dry thickness of 100 nm on a polyethylene naphthalate support (with a centerline surface roughness (Ra value) of 1.5 nm as measured by an optical 3D roughness meter, a crosswise Young's modulus of 8 GPa, and a lengthwise Young's modulus of 6 GPa) 5 μm in thickness, and the magnetic layer coating liquid was coated thereover in a quantity calculated to yield a dry thickness of 70 nm. While the magnetic layer coating liquid was still wet, a magnetic field with a magnetic field strength of 0.6 T was applied in a direction perpendicular to the coated surface to conduct a perpendicular orientation treatment. The magnetic layer coating liquid was then dried. The backcoat layer coating liquid was then coated and dried to a thickness of 0.4 μm on the opposite surface of the support.

A calendar comprised only of metal rolls was then used to conduct a surface leveling treatment at a speed of 100 m/min, a linear pressure of 300 kg/cm, and a temperature of 100° C. A heat treatment was then conducted for 36 hours in a dry environment of 70° C. After the heat treatment, the product was slit to ½ inch width to obtain a magnetic tape.

Evaluation Methods

### 1. Evaluation of Electromagnetic Characteristics (Signal-to-Noise Ratio (SNR))

Magnetic signals were recorded under the conditions indicated below in the lengthwise direction of the various magnetic tapes that had been fabricated, and the signals were reproduced with MR (magnetoresistive) heads. The reproduced signals were frequency analyzed with a Spectrum Analyzer made by Shibasoku. The ratio of the output at 300 kfci to the noise integrated over a range of 0 to 600 kfci was adopted as the SNR.

### (Recording and Reproduction Conditions)

### Recording:

Recording track width 5 μm

Recording gap 0.17 μm

Head saturation flux density Bs 1.8 T

### Reproduction:

Reproduction track width 0.4 μm
Shield distance (sh-sh distance) 0.08 μm
Recording wavelength 300 kfci

### 2. Evaluation of Coating Durability (Scratch Resistance (Alumina Scratches))

In an environment with a temperature of 23° C. and a relative humidity RH of 10%, alumina spheres measuring 4 mm in diameter were run back and forth 20 times with a load of 20 g over the surface of the magnetic layer of each of the magnetic tapes fabricated, the surface of the magnetic layer of the tape was examined under an optical microscope (magnification: 200-fold), and evaluation was conducted based on the following scale.

A: No scratches observed on the surface of the sample in the field of view of the optical microscope
B: Scratches observed in 1 to 5 spots on the surface of the sample in the field of view of the optical microscope
C: Scratches observed in 6 to 10 spots on the surface of the sample in the field of view of the optical microscope
D: Scratches observed in 11 to 50 spots on the surface of the sample in the field of view of the optical microscope
E: Scratches observed in more than 50 spots on the surface of the sample in the field of view of the optical microscope

The results of the above are given in Table 2.

TABLE 2

| | | |
|---|---|---|
| Ferromagnetic | | Coating |
| powder | SNR | durability |

| | | | |
|---|---|---|---|
| Example 2-1 | Example 1-1 | +0.5 dB | A |
| Example 2-2 | Example 1-2 | +0.7 dB | A |
| Example 2-3 | Example 1-3 | +0.5 dB | A |
| Example 2-4 | Example 1-4 | +0.4 dB | A |
| Example 2-5 | Example 1-5 | +0.7 dB | A |
| Comp. Ex. 2-1 | Comp. Ex. 1-1 | ±0.0 dB | C |
| Comp. Ex. 2-2 | Comp. Ex. 1-3 | −0.3 dB | D |
| Comp. Ex. 2-3 | Comp. Ex. 1-4 | −0.5 dB | D |

### 3. Examples and Comparative Examples Relating to Manufacturing Hexagonal Ferrite Powder

### Example 3-1

### (1) Preparing Starting Material Solution

Barium hydroxide (Ba(OH)₂.8H₂O) and iron (III) nitrate (Fe(NO₃)₃.9H₂O) were dissolved in pure water to prepare an aqueous solution containing an iron salt and a barium salt (starting material solution). The combined concentration of the iron salt and barium salt in the starting material solution was 0.075 mol/L, and the molar ratio of Ba/Fe was 0.5

A water-based solution of potassium hydroxide (concentration 0.20 mol/L) was prepared by adding potassium hydroxide to water and dissolving it.

### (2) Preparing an Organic Compound Solution

Oleic acid was dissolved in ethanol to prepare an organic compound solution (concentration 0.75 mol/L).

### (3) Hexagonal Ferrite Synthesis Reaction

The starting material solution prepared in (1) above was introduced into liquid tank 11 of the manufacturing device shown in FIG. 3, the potassium hydroxide water-based solution prepared in (1) above was introduced into liquid tank 12, and the organic compound solution prepared in (2) above was introduced into liquid tank 3. SUS316BA tubing was employed as the piping in the manufacturing device.

High-temperature, high-pressure water was fed to pipe 100 by heating with heater 4 the pure water that had been introduced into liquid tank 1 while feeding it with high-pressure pump 5a. In this process, the temperature and the pressure were controlled so that the temperature of the high-temperature, high-pressure water was 350° C. and the pressure was 30 MPa after passing through heating means 4c.

The starting material solution and the potassium hydroxide water-based solution were fed to pipes 103 and 104 at solution temperatures of 25° C. using heating and pressurizing means (high-pressure pumps) 5d and 5e such that the ratio by volume of the starting material solution:potassium hydroxide water-based solution=50:50; mixed in mixing element M4; and then fed to pipe 105 and mixed with high-pressure, high-temperature water in mixing element M1.

The organic compound solution was fed at a solution temperature of 25° C. to flow passage 102 using a heating and pressurizing means (high-pressure pump) 5c such that the ratio by volume of (starting material solution+potassium hydroxide aqueous solution): organic compound solution=40:60; mixed with the high-temperature, high-pressure water in mixing element M2; and then heated and pressurized in reaction flow passage 6 to synthesize (convert the precursor) hexagonal ferrite.

The mixed flow in reaction flow passage 6 was pressurized to 30 MPa and heated to a temperature of equal to or higher than 300° C. so that the solution temperature (as measured by thermocouple) at discharge outlet D1 of reaction flow passage 6 was 400° C.

Subsequently, the liquid containing hexagonal ferrite was discharged from reaction flow passage 6, cooled to equal to or lower than 100° C. in cooling element 7 equipped with a water-cooling mechanism, passed through pressure-regulating valve 9, and recovered in recovery element 10. A portion of the recovered liquid was collected and the pH was measured with a pH meter (portable pH meter D series, made by Horiba) after being adjusted to a solution temperature of 25° C. Hexagonal ferrite particles were collected from the remainder of the liquid recovered by the recovery element. The particles that were collected were washed with ethanol and then centrifuged to separate the powder.

### Example 3-2

The temperature of the high-temperature, high-pressure water fed to feed passage 100 was lowered within the range of equal to or higher than 200° C. by adjusting the temperature adjustment of heater 4. As a result, the temperature in mixing element M2 became the value indicated in Table 3.

The remainder was conducted in the same manner as in Example 3-1.

### Example 3-3

With the exception that heating was conducted so that the solution temperature at discharge outlet D1 of reaction flow passage 6 became 360° C. (as measured by thermocouple), the same process was implemented as in Example 3-1.

### Comparative Example 3-1

The temperature of the high-temperature, high-pressure water fed to feed passage 100 was increased by adjusting the temperature adjustment of heater 4. As a result, the temperature in mixing element M2 became the value indicated in Table 3.

The remainder was conducted in the same manner as in Example 3-1.

### Comparative Example 3-2

The quantity of potassium hydroxide water-based solution that was added to the precursor-containing water-based solution was reduced below the level in Example 1. As a result, the pH of the solution recovered in the recovery element became the value indicated in Table 1.

The remainder was conducted in the same manner as in Example 3-1.

The hexagonal ferrite powders obtained above were evaluated by the same methods as in Example 1-1 and the like. The results are given in Table 3.

TABLE 3

| | Example | | | Comp. Ex. | |
|---|---|---|---|---|---|
| | 3-1 | 3-2 | 3-3 | 3-1 | 3-2 |
| Solution | 290° C. | 220° C. | 290° C. | 320° C. | 290° C. |
| temperature in | | | | | |
| mixing element | | | | | |
| M2 | | | | | |
| pH following | 6.8 | 6.7 | 6.9 | 6.9 | 5.1 |
| cooling | | | | | |
| Solution | 400° C. | 400° C. | 360° C. | 400° C. | 400° C. |
| temperature at | | | | | |
| discharge outlet | | | | | |
| of reaction | | | | | |
| flow | | | | | |
| passage | | | | | |
| Organic | Oleic acid | Oleic acid | Oleic acid | Oleic acid | Oleic |
| compound | | | | | acid |
| Average major | 17 nm | 15 nm | 14 nm | 24 nm | 36 nm |
| axis length | | | | | |
| Coefficient of | 18% | 18% | 19% | 25% | 27% |
| variation in | | | | | |
| major axis | | | | | |
| length | | | | | |
| Ratio | 90% | 94% | 96% | 43% | 59% |
| accounted | | | | | |
| for by spherical | | | | | |
| particles among | | | | | |
| all particles | | | | | |
| (particle | | | | | |
| number | | | | | |
| ratio) | | | | | |
| Results of | Barium | Barium | Barium | Barium | Hema- |
| identification | ferrite | ferrite | ferrite | ferrite | tite |
| by X-ray | | | | | (Fe₂O₃) |
| diffraction | | | | | |
| analysis | | | | | |

### 4. Examples and Comparative Examples Relating to Magnetic Recording Media (Magnetic Tapes)

### Examples 4-1 to 4-3

### Comparative Examples 4-1 and 4-2

With the exception that the hexagonal ferrite powders prepared in Examples 3-1 to 3-3 and Comparative Examples 3-1 and 3-2 were used, magnetic tapes were prepared in the same manner as in Example 2-1 and the like above and the magnetic tapes fabricated were evaluated in the same manner as in Example 2-1 and the like. The results are given in Table 4. Since the powder prepared in Comparative Example 3-2 was hematite, it was not used to fabricate a magnetic tape.

TABLE 4

| | | |
|---|---|---|
| Ferromagnetic | | Coating |
| powder | SNR | durability |

| | | | |
|---|---|---|---|
| Example 4-1 | Example3-1 | +0.5 dB | A |
| Example 4-2 | Example3-2 | +0.8 dB | A |
| Example 4-3 | Example3-3 | +0.7 dB | A |
| Comp. Ex. 4-1 | Comp. Ex. 3-1 | ±0.0 dB | C |

Evaluation Results

As shown in Tables 2 and 4, the magnetic layers of the magnetic tapes of Examples 2-1 to 2-5 and Examples 4-1 to 4-3 exhibited high coating durability. The magnetic tapes of Examples 2-1 to 2-5 and Examples 4-1 to 4-3 also exhibited good electromagnetic characteristics (high SNRs).

As shown in Tables 1 and 3, the hexagonal ferrite powder employed in the magnetic layer of the magnetic tapes of Examples 2-1 to 2-5 and Examples 4-1 to 4-3 were of small average particle size, exhibited little variation in particle size, and contained many isotropic particles (spherical particles). These points were presumed by the present inventor to contribute to the good electromagnetic characteristics and high coating durability achieved in Tables 2 and 4.

The present invention is useful in a field of manufacturing magnetic recording media for high-density recording.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any Examples thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

What is claimed is:

1. A method of manufacturing hexagonal ferrite powder, which comprises:
introducing a hexagonal ferrite precursor and an organic compound, either simultaneously or sequentially, into a feed passage into which water is being continuously fed while being heated and pressurized;
continuously feeding a water-based solution comprising at least the hexagonal ferrite precursor, the organic compound, and water through the feed passage to a reaction flow passage within which a fluid flowing therein is subjected to heating and pressurizing to convert the hexagonal ferrite precursor into hexagonal ferrite in the reaction flow passage;
discharging and feeding a water-based comprising the hexagonal ferrite from the reaction flow passage to a cooling element; and
recovering the hexagonal ferrite from the water-based solution that has been cooled in the cooling element; wherein
a solution temperature at the point of first contact between the hexagonal ferrite precursor and the organic compound is equal to or higher than 200° C. but lower than 300° C.; and
a pH of the water-based solution that has been cooled is equal to or higher than 6.0 but equal to or lower than 12.0.

2. The method of manufacturing hexagonal ferrite powder according to claim 1, wherein a water-based solution comprising the hexagonal ferrite precursor and a solution comprising the organic compound are sequentially, or following mixing, introduced into the feed passage.

3. The method of manufacturing hexagonal ferrite powder according to claim 1, wherein a water-based solution comprising the hexagonal ferrite precursor is introduced into the feed passage, after which a solution containing the organic compound is introduced.

4. The method of manufacturing hexagonal ferrite powder according to claim 1, which further comprises mixing an iron salt, divalent metal salt, and a base in a water-based solution to prepare a water-based solution that comprises the hexagonal ferrite precursor.

5. The method of manufacturing hexagonal ferrite powder according to claim 4, wherein the iron salt is a barium salt.

6. The method of manufacturing hexagonal ferrite powder according to claim 4, wherein the water-based solution comprising the hexagonal ferrite precursor is prepared by conducting the mixing in a reaction tank.

7. The method of manufacturing hexagonal ferrite powder according to claim 4, wherein the water-based solution comprising the hexagonal ferrite precursor is prepared by converging a feed passage to which a solution comprising an iron salt and a divalent metal salt is being fed with a feed passage to which a base-containing water-based solution is being fed to mix the two solutions.

8. The method of manufacturing hexagonal ferrite powder according to claim 1, wherein the water-based solution comprising at least the hexagonal ferrite precursor, the organic compound, and water is continuously fed while being heated to equal to or higher than 300° C. and pressurized to equal to or higher than 20 MPa in the reaction flow passage.

9. The method of manufacturing hexagonal ferrite powder according to claim 1, wherein a solution temperature of the water-based solution being discharged from the reaction flow passage to the cooling element is equal to or higher than 350° C. but equal to or lower than 450° C.

10. The method of manufacturing hexagonal ferrite powder according to claim 1, wherein the water-based solution is cooled to a solution temperature of equal to or lower than 100° C. in the cooling element.

11. The method of manufacturing hexagonal ferrite powder according to claim 1, wherein the water that is being continuously fed while being heated and pressurized is heated to equal to or higher than 200° C. and pressurized to equal to or higher than 20 MPa.

12. The method of manufacturing hexagonal ferrite powder according to claim 1, wherein the organic compound is selected from the group consisting of an organic carboxylic acid and a salt thereof.

13. The method of manufacturing hexagonal ferrite powder according to claim 1, wherein the organic compound is selected from the group consisting of an organic carboxylic acid with a carbon number ranging from 2 to 24 and a salt thereof.

14. The method of manufacturing hexagonal ferrite powder according to claim 1, wherein the organic compound is selected from the group consisting of oleic acid and a salt thereof.

15. Hexagonal ferrite powder manufactured by the manufacturing method according to claim 1.

16. The hexagonal ferrite powder according to claim 15, which has an average particle size ranging from 10 nm to 30 nm.

17. A magnetic recording medium, which comprises a magnetic layer comprising ferromagnetic powder and binder on a nonmagnetic support, wherein the ferromagnetic powder is the hexagonal ferrite powder according to claim 15.
